(19) United States
(12) Patent Application Publication
(10) Pub. No.: US 2016/0230874 A1
(43) Pub. Date: Aug. 11, 2016

(54) POWER TRANSMISSION DEVICE

(71) Applicant: AISIN AW CO., LTD., Anjo-shi, Aichi-ken (JP)

(72) Inventors: Takeshi TORII, Chiryu (JP); Akihito HATTORI, Anjo (JP)

(73) Assignee: AISIN AW CO., LTD., Anjo-shi, Aichi-ken (JP)

(21) Appl. No.: 15/023,257

(22) PCT Filed: Sep. 29, 2014
(86) PCT No.: PCT/JP2014/075830

§ 371 Date: Mar. 18, 2016

(30) Foreign Application Priority Data
Sep. 30, 2013 (JP) 2013-204874

(51) Int. Cl. F16H 57/021; F16H 3/66; F16H 57/04

(52) U.S. Cl. CPC F16H 57/021; F16H 57/0424; F16H 57/0484; F16H 57/0473; F16H 3/666; F16H 2200/006; F16H 2200/0086; F16H 2200/2046; F16H 2200/2012

(57) ABSTRACT

A power transmission device that includes a transmission; a transmission case that accommodates the transmission; a counter drive gear to which power from the transmission is transmitted; a brake that holds one of rotary elements of the transmission stationary to the transmission case such that the rotary element cannot rotate; and a support member that includes a cylindrical boss portion rotatably supporting the counter drive gear, a wall portion extended outward in a radial direction of the transmission from one end of the boss portion, and a cylindrical drum portion extended in the same direction as that of the boss portion and in an axial direction of the transmission from the wall portion and functioning as a brake drum of the brake, and that is fixed to the transmission case, wherein the boss portion, the wall portion, and the drum portion are formed integrally.

### BACKGROUND

The present disclosure relates to a power transmission device including a transmission, a transmission case that accommodates the transmission, and a counter drive gear to which power from the transmission is transmitted.

A power transmission device that is conventionally known as this type of power transmission device includes: a speed change mechanism having a Ravigneaux type planetary gear set, a multi-plate friction brake that holds a carrier of the planetary gear set stationary to a transmission case such that the carrier cannot rotate, and a one-way clutch that allows the carrier to rotate only in one direction; a counter drive gear to which power from the speed change mechanism is transmitted; and a center support including a cylindrical boss portion that rotatably supports the counter drive gear and a wall portion that is extended outward in the radial direction from one end of the boss portion and that has its outer periphery fastened to the transmission case (see, e.g., Japanese Patent Application Publication No. 2002-349683). In this power transmission device, the counter drive gear is rotatably supported by the boss portion of the center support so as to be located between the wall portion of the center support and the planetary gear set. The brake and the one-way clutch are disposed outside the planetary gear set, and a plurality of friction engagement plates of the brake and the outer periphery of the one-way clutch are fitted in splines formed in the inner peripheral surface of the transmission case.

Another power transmission device that is known as this type of power transmission device includes a multi-plate friction brake that holds one of rotary elements of an automatic transmission stationary to a transmission case accommodating the automatic transmission such that this rotary element cannot rotate, and this power transmission device uses a part of the transmission case also as a brake drum of the brake (see, e.g., Japanese Patent Application Publication No. 2004-36887). In this power transmission device, an oil passage through which coolant is supplied to the brake is formed in the part of the transmission case which is used also as the brake drum.

### SUMMARY

In such conventional power transmission devices, it is necessary to ensure that the center support rotatably supporting the counter drive gear is strong enough to restrain occurrence of noise or vibration. However, if the thickness of the center support is increased or a rib is added in order to secure the strength, an increase in size of the power transmission device cannot be restrained.

The present disclosure according to an exemplary aspect more satisfactorily improves strength of a support member rotatably supporting a counter drive gear to which power from a transmission is transmitted, while restraining an increase in size of a power transmission device.

According to an exemplary aspect the present disclosure, a power transmission device includes a transmission, a transmission case that accommodates the transmission, a counter drive gear to which power from the transmission is transmitted, a brake that holds one of rotary elements of the transmission stationary to the transmission case such that the rotary element cannot rotate; and a support member that includes a cylindrical boss portion rotatably supporting the counter drive gear, a wall portion extended outward in a radial direction of the transmission from one end of the boss portion, and a cylindrical drum portion extended in the same direction as that of the boss portion and in an axial direction of the transmission from the wall portion and functioning as a brake drum of the brake, and that is fixed to the transmission case, wherein the boss portion, the wall portion, and the drum portion are formed integrally.

This power transmission device includes the brake that holds one of the rotary elements of the transmission stationary to the transmission case such that the rotary element cannot rotate, and the support member that rotatably supports the counter drive gear and that is fixed to the transmission case. This support member includes the cylindrical boss portion rotatably supporting the counter drive gear, the wall portion extended outward in the radial direction of the transmission from one end of the boss portion, and the cylindrical drum portion extended in the same direction as that of the boss portion and in the axial direction of the transmission from the wall portion and functioning as the brake drum of the brake. The support member thus functions as the brake drum of the brake, which eliminates the need to provide a portion functioning as the brake drum in other components of the power transmission device such as the transmission case. Since the boss portion, the wall portion, and the drum portion of the support member are formed integrally, the drum portion also functions as a rib. Strength of the support member can therefore be satisfactorily improved. Accordingly, in this power transmission device, an increase in size of the power transmission device can be restrained, and the strength of the support member that rotatably supports the counter drive gear to which power from the transmission is transmitted can be more satisfactorily improved.

The power transmission device may further include: a second brake that holds a second rotary element of the transmission, which is different from the one rotary element, stationary to the transmission case such that the second rotary element cannot rotate. The support member may further include a cylindrical second drum portion extended in an opposite direction to that of the boss portion and the drum portion and in the axial direction from the wall portion and functioning as a brake drum of the second brake, and the second drum portion may be formed integrally with the boss portion, the wall portion, and the drum portion. The support member thus has a function as the brake drum of the second brake. This eliminates the need to provide a portion functioning as the brake drum of the second brake in other components of the power transmission device such as the transmission case. Since the second drum portion is formed integrally with the boss portion, the wall portion, and the drum portion, the second drum portion also functions as a rib. This can restrain an increase in size of the power transmission device and can more satisfactorily improve the strength of the support member.

Moreover, the drum portion and the second drum portion may be extended in opposite directions to each other from substantially the same position in the radial direction in an outer periphery of the wall portion.

In addition, the brake may have a plurality of friction engagement plates that are fitted in splines formed in an inner peripheral surface of the drum portion, and a lubricating oil supply path through which lubricating oil is supplied to the plurality of friction engagement plates may be formed in the support member. A sufficient amount of lubricating oil can thus be supplied to the plurality of friction engagement plates of the brake via the lubricating oil supply path, and the plurality of friction engagement plates can be more satisfactorily lubricated and cooled. As a result, slip engagement of the brake can be effectively used in a wide range, whereby shift speeds can be smoothly formed by engaging or disengaging the brake, and a feeling of torque transmission can further be improved.

Moreover, the transmission case may include a case portion that accommodates at least the one rotary element. The support member may be fixed to the case portion such that the drum portion is fitted in the case portion. The lubricating oil supply path may include an oil passage that is defined by a recess formed in at least one of an inner peripheral surface of the case portion and an outer peripheral surface of the drum portion, and a plurality of through holes that communicate with the oil passage and that extend in the radial direction. At least a part of the plurality of friction engagement plates may be fitted in the drum portion so as to be located inside the recess. Since the support member is fixed to the case portion such that the drum portion is fitted in the case portion, the support member can be more firmly fixed to the transmission case. Since the oil passage forming the lubricating oil supply path is defined by the recess formed in at least one of the inner peripheral surface of the case portion and the outer peripheral surface of the drum portion, this can restrain an increase in thickness of the case portion and the drum portion associated with formation of the lubricating oil supply path. Moreover, since at least a part of the plurality of friction engagement plates is fitted in the drum portion so as to be located inside the recess, lubricating oil can be uniformly supplied to the friction engagement plates via the recess and the plurality of through holes.

The brake may include a piston that together with the transmission case defines an engagement oil chamber and that presses the plurality of friction engagement plates according to an oil pressure supplied to the engagement oil chamber, and a plurality of return springs that bias the piston such that the piston is separated from the plurality of friction engagement plates. The plurality of return springs may be disposed between a tip end of the drum portion and the piston. The plurality of return springs can thus be disposed without interfering with the splines of the drum portion in which the plurality of friction engagement plates are fitted. Accordingly, the plurality of return springs can be arranged at regular intervals in a circumferential direction of the piston, and a biasing force of the plurality of return springs can be uniformly applied to the piston. This restrains tilting of the piston and allows the piston to press the plurality of friction engagement plates such that the plurality of friction engagement plates are not tilted. The brake can thus be slip-engaged more accurately.

The brake may be engaged when the transmission forms a starting speed. Accordingly, slip engagement of the brake is effectively used when the starting speed is formed. The starting speed can thus be smoothly formed, and a feeling of torque transmission can further be improved.

### BRIEF DESCRIPTION OF THE DRAWINGS

FIG. 1 is a schematic configuration diagram of a power transmission device according to an embodiment of the present disclosure.

FIG. 2 is an operation table showing the relationship between each shift speed of an automatic transmission included in the power transmission device of FIG. 1 and the operating state of clutches and brakes.

FIG. 3 is an enlarged partial sectional view of a main part of the power transmission device of FIG. 1.

### DETAILED DESCRIPTION OF EMBODIMENTS

A mode for carrying out the present disclosure will be described with reference to the accompanying drawings.

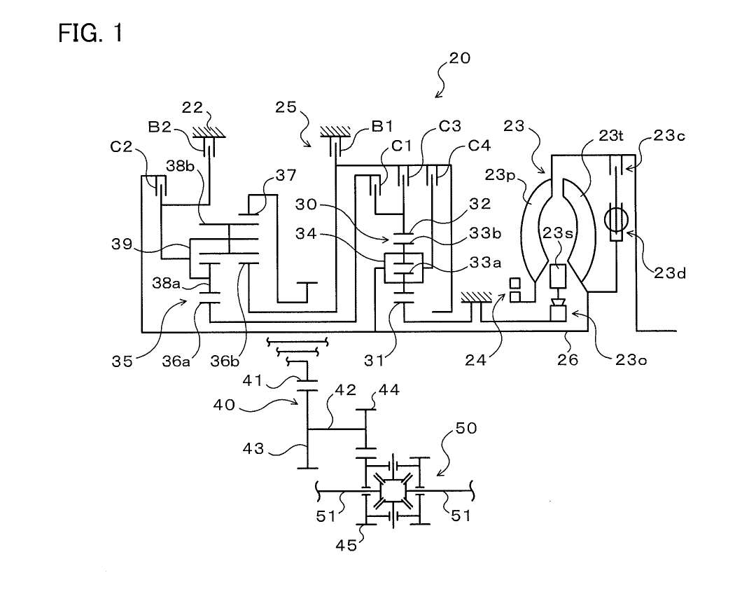

FIG. 1 is a schematic configuration diagram of a power transmission device 20 according to an embodiment of the present disclosure. The power transmission device 20 shown in the figure is connected to a crankshaft of an engine, not shown, which is mounted on a front-wheel drive vehicle, and can transmit power from the engine to left and right driving wheels (front wheels), not shown. As shown in the figure, the power transmission device 20 includes a transmission case 22, and a staring device (hydraulic transmission device) 23, an oil pump 24, an automatic transmission 25, a gear mechanism (gear train) 40, a differential gear (differential mechanism) 50, etc. which are accommodated in the transmission case 22.

The starting device 23 included in the power transmission device 20 is configured as a torque converter having an input-side pump impeller 23p that is connected to the crankshaft of the engine, an output-side turbine runner 23t that is connected to an input shaft (input member) 26 of the automatic transmission 25, a stator 23s that is disposed inside the pump impeller 23p and the turbine runner 23t to adjust the flow of hydraulic oil from the turbine runner 23t to the pump impeller 23p, a one-way clutch 23o that allows the stator 23s to rotate only in one direction, a lockup clutch 23c, a damper mechanism 23d, etc. The starting device 23 may be configured as a fluid coupling that does not have the stator 23s.

The oil pump 24 is configured as a gear pump having a pump assembly including a pump body and a pump cover, an external gear connected to the pump impeller 23p of the starting device 23 via a hub, an internal gear meshing with the external gear, etc. The oil pump 24 is driven by the power from the engine to suction hydraulic oil (ATF) accumulated in an oil pan, not shown, to pressure-feed the suctioned hydraulic oil to a hydraulic control device, not shown, which generates an oil pressure required by the starting device 23 or the automatic transmission 25.

The automatic transmission 25 is configured as an eight-speed transmission. As shown in FIG. 1, the automatic transmission 25 includes, in addition to the input shaft 26, a double-pinion type first planetary gear mechanism 30, a Ravigneaux type second planetary gear mechanism 35, four clutches C1, C2, C3, C4 that change a power transmission path from the input side to the output side, and two brakes B1, B2.

The first planetary gear mechanism 30 of the automatic transmission 25 has a sun gear 31 as an external gear, a ring gear 32 as an internal gear that is disposed concentrically with the sun gear 31, and a planetary carrier 34 that holds a plurality of pairs of pinion gears 33a, 33b such that the pinion gears 33a, 33b can rotate (turn) and revolve. Each pair of pinion gears 33a, 33b mesh with each other, one of each pair of pinion gears 33a, 33b meshes with the sun gear 31, and the other pinion gear meshes with the ring gear 32. As shown in the figure, the sun gear 31 of the first planetary gear mechanism 30 is fixed to the transmission case 22, and the planetary carrier 34 of the first planetary gear mechanism 30 is coupled to the input shaft 26 such that the planetary carrier 34 can rotate together with the input shaft 26. The first planetary gear mechanism 30 is configured as what is called a reduction gear. The first planetary gear mechanism 30 reduces the rotational speed of the power transmitted to the planetary carrier 34 as an input element, and outputs the resultant power from the ring gear 32 as an output element.

The second planetary gear mechanism 35 of the automatic transmission 25 has a first sun gear 36a and a second sun gear 36b as external gears, a ring gear 37 as an internal gear that is disposed concentrically with the first and second sun gears 36a, 36b, a plurality of short pinion gears 38a that mesh with the first sun gear 36a, a plurality of long pinion gears 38b that mesh with the second sun gear 36b and the plurality of short pinion gears 38a and mesh with the ring gear 37, and a planetary carrier 39 that holds the plurality of short pinion gears 38a and the plurality of long pinion gears 38b such that the plurality of short pinion gears 38a and the plurality of long pinion gears 38b can rotate (turn) and revolve. The ring gear 37 of the second planetary gear mechanism 35 functions as an output member of the automatic transmission 25, and the power transmitted from the input shaft 26 to the ring gear 37 is transmitted to the left and right driving wheels via the gear mechanism 40, the differential gear 50, and drive shafts 51.

The clutch C1 is a multi-plate friction hydraulic clutch (friction engagement element) that has a hydraulic servo formed by a piston, a plurality of friction plates and separator plates, an oil chamber to which hydraulic oil is supplied, etc. and that can connect and disconnect the ring gear 32 of the first planetary gear mechanism 30 to and from the first sun gear 36a of the second planetary gear mechanism 35. The clutch C2 is a multi-plate friction hydraulic clutch that has a hydraulic servo formed by a piston, a plurality of friction plates and separator plates, an oil chamber to which hydraulic oil is supplied, etc. and that can connect and disconnect the input shaft 26 to and from the planetary carrier 39 of the second planetary gear mechanism 35. The clutch C3 is a multi-plate friction hydraulic clutch that has a hydraulic servo formed by a piston, a plurality of friction plates and separator plates, an oil chamber to which hydraulic oil is supplied, etc. and that can connect and disconnect the ring gear 32 of the first planetary gear mechanism 30 to and from the second sun gear 36b of the second planetary gear mechanism 35. The clutch C4 is a multi-plate friction hydraulic clutch that has a hydraulic servo formed by a piston, a plurality of friction plates and separator plates, an oil chamber to which hydraulic oil is supplied, etc. and that can connect and disconnect the planetary carrier 34 of the first planetary gear mechanism 30 to and from the second sun gear 36b of the second planetary gear mechanism 35.

The brake B1 is a multi-plate friction hydraulic brake that has a hydraulic servo formed by a plurality of friction plates and separator plates, an oil chamber to which hydraulic oil is supplied, etc., that can hold the second sun gear 36b of the second planetary gear mechanism 35 stationary to the transmission case 22 such that the second sun gear 36b cannot rotate, and that can release the second sun gear 36b from the transmission case 22. The brake B2 is a multi-plate friction hydraulic clutch that has a hydraulic servo formed by a plurality of friction plates and separator plates, an oil chamber to which hydraulic oil is supplied, etc., that can hold the planetary carrier 39 of the second planetary gear mechanism 35 stationary to the transmission case 22 such that the planetary carrier 39 cannot rotate, and that can release the planetary carrier 39 from the transmission case 22.

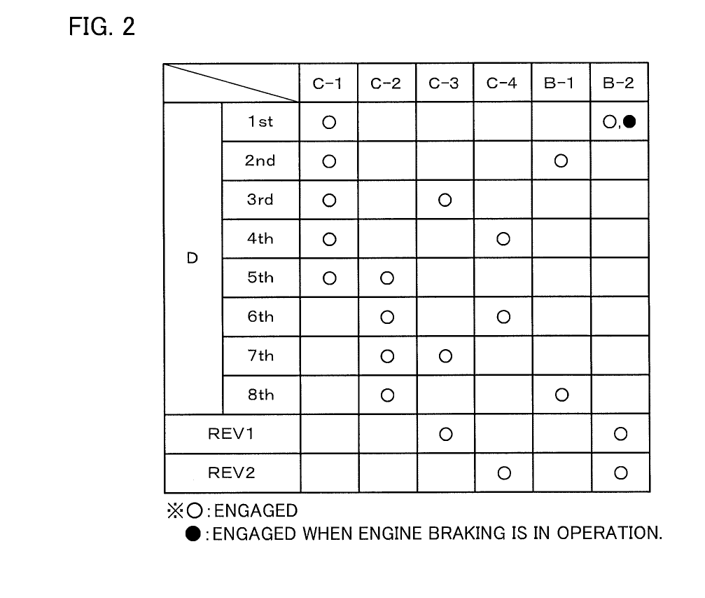

The clutches C1 to C4 and the brakes B1, B2 operate according to supply and discharge of hydraulic oil by the hydraulic control device. FIG. 2 is an operation table showing the relationship between each shift speed of the automatic transmission 25 and the operating state of the clutches C1 to C4 and the brakes B1, B2. The automatic transmission 25 provides first to eighth forward speeds and first and second reverse speeds by switching the clutches C1 to C4 and the brakes B1, B2 to the states shown in the operation table of FIG. 2. At least one of the clutches C1 to C4 may be a meshing engagement element such as a dog clutch.

The gear mechanism 40 has a counter drive gear 41 that is coupled to the ring gear 37 of the second planetary gear mechanism 35 of the automatic transmission 25, a counter driven gear 43 that is fixed to a counter shaft 42 extending parallel to the input shaft 26 of the automatic transmission 25 and that meshes with the counter drive gear 41, a drive pinion gear (final drive gear) 44 that is formed integrally with (or fixed to) the counter shaft 42 so as to be separated from the counter driven gear 43 in the axial direction, and a differential ring gear (final driven gear) 45 that meshes with the drive pinion gear 44 and that is coupled to the differential gear 50.

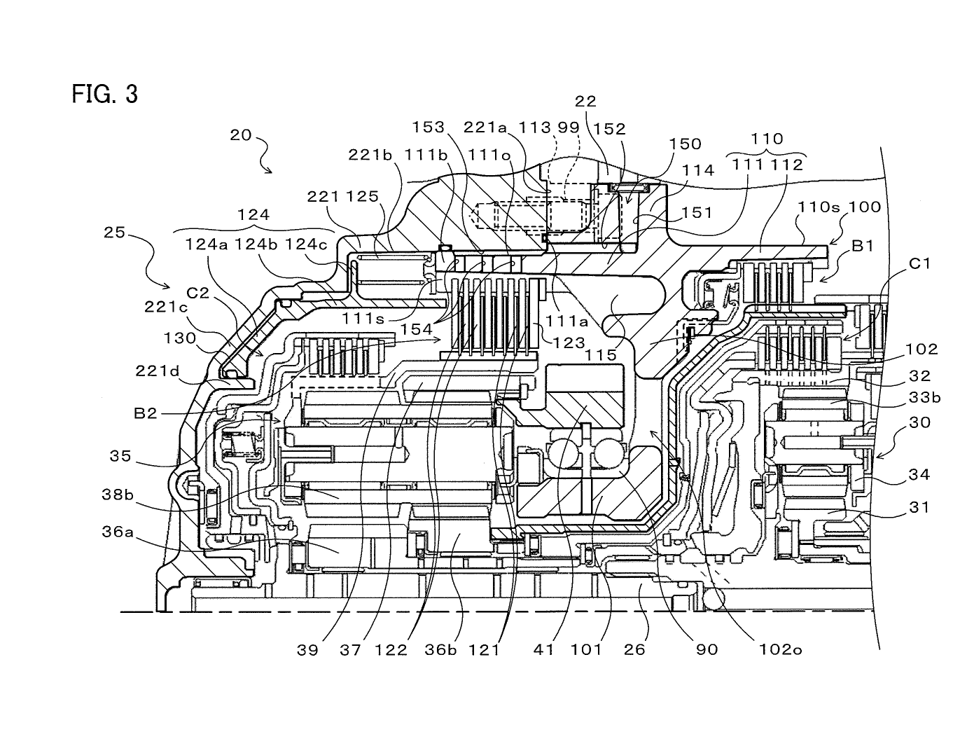

The configuration around the counter drive gear 41 of the gear mechanism 40 and the brake B2 of the automatic transmission 25 will be described below with reference to FIG. 3.

As shown in the figure, the counter drive gear 41 of the gear mechanism 40 which is coupled to the ring gear 37 of the second planetary gear mechanism 35 is rotatably supported by a support member (center support) 100 that is fixed to the transmission case 22 via a plurality of bolts 99. The support member 100 includes a cylindrical boss portion 101 that rotatably supports the counter drive gear 41 via a bearing 90, a substantially disc-shaped wall portion 102 extended outward in the radial direction of the input shaft 26 (the automatic transmission 25) (hereinafter simply referred to as the “radial direction”) from one end of the boss portion 101, and an outer tube portion 110 extended in the axial direction of the input shaft 26 (the automatic transmission 25) (hereinafter simply referred to as the “axial direction”) from the wall portion 102.

The boss portion 101 of the support member 100 is formed in a cylindrical shape and has a central hole through which the input shaft 26 etc. are inserted. As shown in FIG. 3, the wall portion 102 is extended outward in the radial direction from the opposite end of the boss portion 101 from the second planetary gear mechanism 35 and extends between the boss portion 101 and the outer tube portion 110. A plurality of lightening holes 102o are formed in the wall portion 102 in order to reduce the weight of the support member 100. The outer tube portion 110 includes a first drum portion 111 that is extended in the same direction as that of the boss portion 101 (to the second planetary gear mechanism 35 side) and in the axial direction from the outer periphery of the wall portion 102, and a second drum portion 112 that is extended in the opposite direction to that of the boss portion 101 and the first drum portion 111 (to the opposite side from the second planetary gear mechanism 35) and in the axial direction from the outer periphery of the wall portion 102. That is, the first and second drum portions 111, 112 are extended in the opposite directions to each other from substantially the same position in the radial direction in the outer periphery of the wall portion 102. The first and second drum portions 111, 112 may be extended from the wall portion 102 such that their positions in the radial direction are slightly offset form each other.

The outer tube portion 110 (the first and second drum portions 111, 112) has an outer peripheral surface 110s in the form of a cylindrical surface, and a plurality of fastening portions 113 having bolt holes through which the bolts 99 are inserted are extended outward in the radial direction from the outer peripheral surface 110s of a substantially middle part in the axial direction of the first drum portion 111. A projecting portion 114 is formed so as to project from the outer peripheral surface 110s of a substantially middle part in the axial direction of the outer tube portion 110 of the support member 100 toward the hydraulic control device, not shown, which is disposed outside the transmission case 22. The projecting portion 114 is offset in the circumferential direction so as not to overlap the plurality of fastening portions 113 in the axial direction, and is extended from the outer peripheral surface 110s of the outer tube portion 110 so as to contact an inner wall of the transmission case 22. In the present embodiment, the hydraulic control device, not shown, is attached to a side part of the transmission case 22. The first drum portion 111 of the outer tube portion 110 includes a cutout portion, not shown, which is formed so as to avoid interference with a meshing portion between the counter drive gear 41 and the counter driven gear 43.

The transmission case 22 to which the support member 100 is fixed includes a rear cover 221 that accommodates the second planetary gear mechanism 35, the brake B2, the clutch C2, etc. The first drum portion 111 of the support member 100 is fitted in a wall portion 221b extending in the axial direction from an end face 221a on the first planetary gear mechanism 30 side of the rear cover 221 such that a stepped part 111a formed in the outer periphery of the first drum portion 111 contacts the end face 221a of the rear cover 221. The support member 100 is fastened (fixed) to the rear cover 221 by the bolts 99 inserted through the bolt holes of the plurality of fastening portions 113 such that the first drum portion 111 is fitted in the wall portion 221b of the rear cover 221. The support member 100 can thus be stably and firmly fixed to the rear cover 221 (the transmission case 22), so that the support member 100 is not subjected to excessive stress.

As shown in FIG. 3, the inner periphery of the first drum portion 111 of the support member 100 having the above configuration is provided with splines 111s in which the outer peripheries of friction engagement plates (the separator plates) of the brake B2 are fitted. The first drum portion 111 functions as a brake drum of the brake B2 that holds the planetary carrier 39 of the second planetary gear mechanism 35 stationary to the transmission case 22 such that the planetary carrier 39 cannot rotate. The inner periphery of the second drum portion 112 is provided with splines in which the outer peripheries of friction engagement plates (the separator plates) of the brake B1 are fitted. The second drum portion 112 functions as a brake drum of the brake B1 that holds the second sun gear 36b of the second planetary gear mechanism 35 stationary to the transmission case 22 such that the second sun gear 36b cannot rotate.

As described above, the support member 100 functions as the brake drums of the brakes B1, B2. This eliminates the need to provide portions functioning as the brake drums in other components of the power transmission device 20 such as the transmission case 22. In the present embodiment, the boss portion 101, the wall portion 102, and the first and second drum portions 111, 112 of the support member 100 are formed integrally by casting or forging an aluminum alloy. Therefore, the first and second drum portions 111, 112 each also function as a rib. Accordingly, in the power transmission device 20, an increase in overall size of the device can be restrained, and strength of the support member 100 can be more satisfactorily improved. In the present embodiment, a plurality of ribs 115 are also formed in a radial pattern between the inner peripheral surface of the first drum portion 111 and the wall portion 102. This can also more satisfactorily improve the strength of the support member 100.

As shown in FIG. 3, the brake B2 that uses the first drum portion 111 of the support member 100 as its brake drum includes a plurality of friction plates 121 that are fitted on the outer peripheral surface of the planetary carrier 39 of the second planetary gear mechanism 35 and that are supported by the planetary carrier 39 such that the friction plates 121 can move, a plurality of separator plates 122 that are fitted in the splines 111s formed in the inner peripheral surface of the first drum portion 111 and that are supported by the first drum portion 111 such that the separator plates 122 can move, and a backing plate 123 that is fitted on the spline 111s of the first drum portion 111.

Splines that can engage with projections and recesses which are formed in the inner peripheral surface of each friction plate 121 are formed in the outer peripheral surface of the planetary carrier 39 of the second planetary gear mechanism 35. The friction plate 121 is an annular member having a friction material adhesively attached to both surfaces thereof. The separator plate 122 is an annular member both surfaces of which are smooth. The separator plates 122 are fitted in the splines 111s of the first drum portion 111 so as be arranged alternately with the plurality of friction plates 121 fitted on the planetary carrier 39. The backing plate 123 is fitted in the spline 111s of the first drum portion 111 such that the backing plate 123 can contact the friction plate 121 disposed closest to the wall portion 102. The backing plate 123 is supported in the axial direction by a snap ring attached to the first drum portion 111.

The brake B2 includes a piston 124 that together with the rear cover 221 defines an engagement oil chamber 130 and that presses the friction plates 121 and the separator plates 122 according to an oil pressure supplied to the engagement oil chamber 130, and a plurality of return springs 125 that bias the piston 124 in such a direction that the piston 124 is separated from the friction plates 121 and the separator plates 122.

The piston 124 includes an oil chamber defining portion 124a that is formed so as to extend substantially along a sidewall portion 221c of the rear cover 221, a pressing portion 124b that are extended in the axial direction from the oil chamber defining portion 124a and that can press the friction plates 121 and the separator plates 122, and a spring support portion 124c that is extended outward in the radial direction in the shape of a disc from a substantially middle part in the axial direction of the pressing portion 124b. The piston 124 is disposed inside the rear cover 221 such that the inner periphery of the oil chamber defining portion 124a slidingly contacts, via a sealing member, an annular piston support portion 221d extended in the axial direction from the sidewall portion 221c of the rear cover 221 and such that the outer periphery of the oil chamber defining portion 124a slidingly contacts, via a sealing member, a part of the sidewall portion 221c which extends in the axial direction.

The piston 124 is thus supported by the sidewall portion 221c and the piston support portion 221d of the rear cover 221 such that the piston 124 can move in the axial direction, and the engagement oil chamber 130 is defined by the oil chamber defining portion 124a of the piston 124 and the sidewall portion 221c and the piston support portion 221d of the rear cover 221. An engagement oil pressure (hydraulic oil) for engaging the brake B2 is supplied from the hydraulic control device to the engagement oil chamber 130 via an oil passage, not shown, which is formed in the rear cover 221. The piston 124 thus moves to press the friction plates 121 and the separator plates 122 according to the engagement oil pressure supplied to the engagement oil chamber 130, thereby frictionally engaging (fully engaging or slip-engaging) the friction plates 121 and the separator plates 122.

The plurality of return springs 125 are arranged at regular intervals in the circumferential direction of the piston 124 between an tip end 111b of the first drum portion 111 and the spring support portion 124c extended outward in the radial direction from the pressing portion 124b of the piston 124. As described above, each return spring 125 biases the piston 124 such that the piston 124 is separated from the friction plates 121 and the separator plates 122. If an oil pressure supplied from the hydraulic control device to the engagement oil chamber 130 decreases, the piston 124 is separated from the friction plates 121 and the separator plates 122 by the biasing force of each return spring 125, whereby the brake B1 is disengaged.

An oil passage structure that supplies lubricating oil to the brake B2 having the above configuration will be described below. As shown in FIG. 3, a lubricating oil supply path 150 through which lubricating oil from the hydraulic control device, not shown, is supplied to the brake B2 is formed in the support member 100 including the first drum portion 111 that functions as the brake drum of the brake B2.

The lubricating oil supply path 150 includes a first oil passage 151 extending in the projecting portion 114 formed in the support member 100, a second oil passage 152 communicating with the first oil passage 151 and extending in the axial direction in the first drum portion 111, a third oil passage 153 communicating with the second oil passage 152 and defined by the inner peripheral surface of the wall portion 221b of the rear cover 221 and an annular recess 111o formed in the outer peripheral surface 110s of the first drum portion 111, and a plurality of through holes 154 communicating with the third oil passage 153 and extending in the radial direction.

The first oil passage 151 is connected to a lubricating system of the hydraulic control device, not shown, via an oil passage formed in the transmission case 22 that contacts the projecting portion 114. The second oil passage 152 is formed in the first drum portion 111 so as to extend from the terminal end of the first oil passage 151 to the stepped part 111a that contacts the end face 221a of the rear cover 221. The second oil passage 152 is open at the stepped part 111a. A sealing member is interposed between the end face 221a of the rear cover 221 and the stepped part 111a of the first drum portion 111 which contact each other at a position outside the second oil passage 152. In the present embodiment, the sealing member is disposed in a recess formed in the rear cover 221. However, a recess where the sealing member is disposed may be formed in the stepped part 111a of the first drum portion 111.

The recess 111o that defines the third oil passage 153 is formed in an annular shape along the outer peripheral surface 110s of the first drum portion 111, except for the tip end 111b of the first drum portion 111, that is fitted in the wall portion 221b of the rear cover 221. This can restrain an increase in thickness of the rear cover 221 and the first drum portion 111 associated with formation of the third oil passage 153 (the lubricating oil supply path 150). A sealing member is interposed between the inner peripheral surface of the wall portion 221b of the rear cover 221 and the outer peripheral surface 110s of the tip end 111b of the first drum portion 111. In the present embodiment, this sealing member is disposed in a recess formed in the wall portion 221b of the rear cover 221. However, a recess where this sealing member is disposed may be formed in the outer periphery of the tip end 111b of the first drum portion 111.

The plurality of through holes 154 are formed in the first drum portion 111 so as to extend from the bottom of the recess 111o formed in the outer peripheral surface 110s of the first drum portion 111 to the bottoms of the splines 111s formed in the inner peripheral surface of the first drum portion 111. As shown in FIG. 3, the plurality of through holes 154 are formed at predetermined intervals in the axial direction along the respective bottoms of the splines 111s. The plurality of through holes 154 may be formed in all the bottoms of the splines 111s or may be formed in some of the bottoms of the splines 111s.

According to such an oil passage structure, lubricating oil can be directly and sufficiently supplied from the lubricating system of the hydraulic control device to the friction plates 121 and the separator plates 122 of the brake B2 via the lubricating oil supply path 150, and the friction plates 121 and the separator plates 122 can be more satisfactorily lubricated and cooled. As shown in FIG. 3, the friction plates 121 and the separator plates 122 of the brake B1 are fitted in the splines 111s of the first drum portion 111 so that the friction plates 121 and the separator plates 122 except the separator plate 122 disposed closest to the piston 124 are located inside the recess 111o (within the range where the recess 111o is formed in the first drum portion 111). Lubricating oil can thus be uniformly supplied to the friction plates 121 and the separator plates 122 via the recess 111o, which forms the third oil passage 153 of the lubricating oil supply path 150, and the plurality of through holes 154. Lubricating oil that flows from the input shaft 26 side toward the outer periphery through the second planetary gear mechanism 35 is also supplied to the friction plates 121 and the separator plates 122 via an oil hole, not shown, which is formed in the planetary carrier 39.

As described above, in the power transmission device 20 of the present embodiment, lubricating and cooling performance for the brake B2 which is engaged when a starting speed (first speed) with a high gear ratio is formed (see FIG. 2) and for which relatively large torque capacity is required can be very satisfactorily improved. As a result, slip engagement of the brake B2 can be effectively used in a wide range. Accordingly, judders (vibration) of the brake B2 can be more satisfactorily restrained when the starting speed is formed by engaging the brake B2, when engine brake is in operation in the vehicle etc., or when the second speed is formed by disengaging the brake B2. These operations can thus be smoothly performed. This can also improve a feeling of torque transmission at the time these shift speeds are formed or the engine brake is in operation.

In addition, the improved lubricating and cooling performance for the brake B2 allows slip engagement of the brake B2 to be used in more situations. A one-way clutch that restricts rotation of the planetary carrier 39 in one direction therefore need not be used to form the starting speed for which relatively large torque capacity is required in order to hold the planetary carrier 39 of the second planetary gear mechanism 35 stationary to the transmission case 22 such that the planetary carrier 39 cannot rotate. That is, the power transmission device 20 can carry out a function similar to that of the one-way clutch by fully engaging and slip-engaging the brake B2. The one-way clutch can thus be omitted from the device, and the overall weight of the device can be reduced.

In the case of using the one-way clutch that restricts rotation of the planetary carrier 39 of the second planetary gear mechanism 35 in one direction, an outer race of the one-way clutch, in addition to the separator plates 122 of the brake B2 etc., need to be fitted in the splines 111s of the first drum portion 111. However, omitting the one-way clutch from the power transmission device 20 as in the present embodiment increases the degree of design freedom of the first drum portion 111 and the brake B2. For example, the spline 111s of the first drum portion 111 can be designed by taking only the relationship with the separator plates 122 of the brake B2 into consideration. As a result, sufficient space can be secured around the brake B2, and the plurality of return springs 125 of the brake B2 can be disposed without interfering with the splines 111s of the first drum portion 111. As described above, in the present embodiment, the plurality of return springs 125 are arranged at regular intervals in the circumferential direction of the piston 124 between the tip end 111b (the end face thereof) of the first drum portion 111 and the spring support portion 124c. The biasing force of the plurality of return springs can thus be uniformly applied to the piston 124. This restrains tilting of the piston 124 and allows the piston 124 to press the friction plates 121 and the separator plates 122 such that the friction plates 121 and the separator plates 122 are not tilted. The brake B2 can thus be slip-engaged more accurately.

As described above, the power transmission device 20 includes the brake B2 that holds the planetary carrier 39 of the second planetary gear mechanism 35 of the automatic transmission 25 stationary to the transmission case 22 such that the planetary carrier 39 cannot rotate, and the support member 100 that rotatably supports the counter drive gear 41 and that is fixed to the transmission case 22. The support member 100 includes the cylindrical boss portion 101 that rotatably supports the counter drive gear 41, the wall portion 102 that is extended outward in the radial direction of the automatic transmission 25 from one end of the boss portion 101, and the cylindrical first drum portion 111 that is extended in the same direction as that of the boss portion 101 and in the axial direction from the wall portion 102 and that functions as the brake drum of the brake B2. The support member 100 thus has a function of the brake drum of the brake B2, which eliminates the need to provide a portion functioning as the brake drum of the brake B2 in other components of the power transmission device 20 such as the transmission case 22. Since the boss portion 101, the wall portion 102, and the first drum portion 111 of the support member 100 are formed integrally, the first drum portion 111 also functions as a rib. The strength of the support member 100 can therefore be satisfactorily improved. Accordingly, in this power transmission device 20, an increase in size of the power transmission device 20 can be restrained, and the strength of the support member 100 that rotatably supports the counter drive gear 41 to which power from the automatic transmission 25 is transmitted can be more satisfactorily improved.

This power transmission device 20 may include the brake B1 that holds the second sun gear 36b of the second planetary gear mechanism 35 of the automatic transmission 25 stationary to the transmission case 22 such that the second sun gear 36b cannot rotate. The support member 100 includes the cylindrical second drum portion 112 that is extended in the opposite direction to that of the boss portion 101 and the first drum portion 111 and in the axial direction from the wall portion 102 and that functions as the brake drum of the brake B1. The second drum portion 112 is formed integrally with the boss portion 101, the wall portion 102, and the first drum portion 111. The support member 100 thus has a function as the brake drum of the brake B1, which eliminates the need to provide a portion functioning as the brake drum of the brake B1 in other components of the power transmission device 20 such as the transmission case 22. Since the second drum portion 112 is formed integrally with the boss portion 101, the wall portion 102, the first drum portion 111, the second drum portion 112 also functions as a rib. This can restrain an increase in size of the power transmission device 20 and can more satisfactorily improve the strength of the support member 100.

The first drum portion 111 and the second drum portion 112 are extended in the opposite directions to each other from substantially the same position in the radial direction in the outer periphery of the wall portion 102.

The brake B2 has the plurality of separator plates 122 that are fitted in the splines 111s formed in the inner peripheral surface of the first drum portion 111, and the lubricating oil supply path 150 through which lubricating oil is supplied to the plurality of separator plates 122 and the plurality of friction plates 121 frictionally engaging with the plurality of separator plates 122 is formed in the support member 100. A sufficient amount of lubricating oil can thus be supplied to the friction plates 121 and the separator plates 122 of the brake B2 via the lubricating oil supply path 150, and the friction plates 121 and the separator plates 122 can be more satisfactorily lubricated and cooled. As a result, slip engagement of the brake B2 can be effectively used in a wide range, whereby the shift speeds can be smoothly formed by engaging or disengaging the brake B2, and a feeling of torque transmission can further be improved.

Moreover, the transmission case 22 includes the rear cover 221 that accommodates at least the second planetary gear mechanism 35. The support member 100 is fixed to the rear cover 221 such that the first drum portion 111 is fitted in the rear cover 221. The lubricating oil supply path 150 includes the third oil passage 153 defined by the inner peripheral surface of the wall portion 221b of the rear cover 221 and the recess 111o formed in the outer peripheral surface of the first drum portion 111, and the plurality of through holes 154 communicating with the third oil passage 153 and extending in the radial direction. At least a part of the friction plates 121 and the separator plates 122 is fitted in the first drum portion 111 so as to be located inside the recess 111o. Since the support member 100 is fixed to the rear cover 221 such that the first drum portion 111 is fitted in the rear cover 221, the support member 100 can be more firmly fixed to the transmission case 22. Since the third oil passage 153 forming the lubricating oil supply path 150 is defined by the inner peripheral surface of the rear cover 221 and the recess 111o formed in the outer peripheral surface of the first drum portion 111, this can restrain an increase in thickness of the rear cover 221 and the first drum portion 111 associated with formation of the lubricating oil supply path 150. Moreover, since at least a part of the friction plates 121 and the separator plates 122 is fitted in the first drum portion 111 so as to be located inside the recess 111o, lubricating oil can be uniformly supplied to the friction plates 121 and the separator plates 122 via the recess 111o and the plurality of through holes 154.

The brake B2 includes the piston 124 that together the transmission case 22 defines the engagement oil chamber 130 and that presses the friction plates 121 and the separator plates 122 according to an oil pressure supplied to the engagement oil chamber 130, and the plurality of return springs 125 that bias the piston 124 such that the piston 124 is separated from the friction plates 121 and the separator plates 122. The plurality of return springs 125 are disposed between the tip end 111b of the first drum portion 111 and the piston 124. The plurality of return springs 125 can thus be disposed without interfering with the splines 111s of the first drum portion 111 in which the separator plates 122 are fitted. Accordingly, the plurality of return springs 125 can be arranged at regular intervals in the circumferential direction of the piston 124, and the biasing force of the plurality of return springs 125 can be uniformly applied to the piston 124. This restrains tilting of the piston 124 and allows the piston 124 to press the friction plates 121 and the separator plates 122 such that the friction plates 121 and the separator plates 122 are not tilted. The brake B2 can thus be slip-engaged more accurately.

Moreover, the brake B2 is engaged when the automatic transmission 25 forms the starting speed. Accordingly, slip engagement of the brake B2 is effectively used when the starting speed is formed. The starting speed can thus be smoothly formed, and a feeling of torque transmission can further be improved.

However, the brake B2 may be any brake that can hold one of rotary elements included in the automatic transmission 25 stationary to the transmission case 22 such that the rotary element cannot rotate. The brake B2 is not limited to the brake that is engaged when the starting speed is formed. The brake B1 may be any brake that can hold a second rotary element, which is different from the rotary element that is held stationary by the brake B2 such that the rotary element cannot rotate, stationary to the transmission case 22 such that the second rotary element cannot rotate. Moreover, the second drum portion 112 that functions as the brake drum of the brake B1 may be omitted from the support member 100. In this case, other components included in the power transmission device 20 can be used as the brake drum of the brake B1.

The first drum portion 111 of the support member 100 need not necessarily be fitted in the wall portion 221b of the rear cover 221. Moreover, the lubricating oil supply path 150 formed in the support member 100 is not limited to the configuration of the present embodiment. For example, the third oil passage 153 of the lubricating oil supply path 150 may be defined by the outer peripheral surface 110s of the first drum portion 111 that is fitted in the wall portion 221b of the rear cover 221 and a recess that is formed in the wall portion 221b of the rear cover 221 so as to extend along the outer peripheral surface 110s. The lubricating oil supply path 150 may be omitted from the support member 100, and only the lubricating oil that flows from the input shaft 26 side toward the outer periphery through the second planetary gear mechanism 35 may be supplied to the friction plates 121 and the separator plates 122 of the brake B2 via the oil hole, not shown, which is formed in the planetary carrier 39.

The plurality of return springs 125 of the brake B1 are not limited to the return springs disposed between the tip end 111b of the first drum portion 111 and the piston 124. The plurality of return springs 125 may be any return springs that are disposed between a member fixed to the transmission case 22 and the piston 124. For example, the wall portion 221b of the rear cover 221 may have an extended portion extended inward in the radial direction from the wall portion 221b, and the plurality of return springs 125 may be disposed between the extended portion and the piston 124. Although the automatic transmission 25 included in the power transmission device 20 of the present embodiment does not have a one-way clutch that restricts rotation of the planetary carrier 39 of the second planetary gear mechanism 35 in one direction, the present disclosure may be applied to a power transmission device including an automatic transmission having such a one-way clutch.

Correspondence between the main elements of the above embodiment etc. and the main elements of the disclosure described in “SUMMARY” will be described. In the above embodiment etc., the power transmission device 20 including the automatic transmission 25, the transmission case 22 accommodating the automatic transmission 25, and the counter drive gear 41 to which power from the automatic transmission 25 is transmitted corresponds to the “power transmission device.” The brake B2 that holds the planetary carrier 39 of the second planetary gear mechanism 35 of the automatic transmission 25 stationary to the transmission case 22 such that the planetary carrier 39 cannot rotate corresponds to the “brake.” The cylindrical boss portion 101 that rotatably supports the counter drive gear 41 corresponds to the “boss portion.” The wall portion 102 extended outward in the radial direction of the automatic transmission 25 from one end of the boss portion 101 corresponds to the “wall portion.” The cylindrical first drum portion 111 extended in the same direction as that of the boss portion 101 and in the axial direction from the wall portion 102 and functioning as the brake drum of the brake B2 corresponds to the “drum portion.” The support member 100 including the boss portion 101, the wall portion 102, and the first drum portion 111 and fixed to the transmission case 22 corresponds to the “support member.” The brake B1 that holds the second sun gear 36b of the second planetary gear mechanism 35 of the automatic transmission 25 stationary to the transmission case 22 such that the second sun gear 36b cannot rotate corresponds to the “second brake.” The cylindrical second drum portion 112 extended in the opposite direction to that of the boss portion 101 and the first drum portion 111 and in the axial direction from the wall portion 102 of the support member 100 and functioning as the brake drum of the brake B2 corresponds to the “second drum portion.” The plurality of separator plates 122 of the brake B2 corresponds to the “plurality of friction engagement plates.” The lubricating oil supply path 150 formed in the support member corresponds to the “lubricating oil supply path.” The rear cover 221 accommodating at least the second planetary gear mechanism 35 corresponds to the “case portion.” The third oil passage 153 defined by the inner peripheral surface of the rear cover 221 and the recess 111o formed in the outer peripheral surface 110s of the first drum portion 111 corresponds to the “oil passage.” The plurality of through holes 154 communicating with the third oil passage and extending in the radial direction correspond to the “plurality of through holes.” The piston 124 that together with the transmission case 22 defines the engagement oil chamber 130 and that presses the friction plates 121 and the separator plates 122 according to an oil pressure supplied to the engagement oil chamber 130 corresponds to the “piston.” The plurality of return springs 125 that bias the piston 124 such that the piston 124 is separated from the friction plates 121 and the separator plates 122 correspond to the “plurality of return springs.”

Although the embodiment of the present disclosure is described above, it should be understood that the present disclosure is not limited in any way to the above embodiment, and various modifications can be made without departing from the spirit and scope of the present disclosure. The above mode for carrying out the disclosure is merely shown as a specific form of the disclosure described in “SUMMARY” and is not intended to limit the elements of the disclosure described in “SUMMARY.”

### INDUSTRIAL APPLICABILITY

The present disclosure is applicable to manufacturing industries of power transmission devices, etc.

1. A power transmission device comprising:
a transmission;
a transmission case that accommodates the transmission;
a counter drive gear to which power from the transmission is transmitted;
a brake that holds one of rotary elements of the transmission stationary to the transmission case such that the rotary element cannot rotate; and
a support member that includes:
a cylindrical boss portion rotatably supporting the counter drive gear,
a wall portion extended outward in a radial direction of the transmission from one end of the boss portion, and
a cylindrical drum portion extended in the same direction as that of the boss portion and in an axial direction of the transmission from the wall portion and functioning as a brake drum of the brake, and that is fixed to the transmission case, wherein
the boss portion, the wall portion, and the drum portion are formed integrally.

2. The power transmission device according to claim 1, further comprising:
a second brake that holds a second rotary element of the transmission, which is different from the one rotary element, stationary to the transmission case such that the second rotary element cannot rotate, wherein
the support member further includes a cylindrical second drum portion extended in an opposite direction to that of the boss portion and the drum portion and in the axial direction from the wall portion and functioning as a brake drum of the second brake, and
the second drum portion is formed integrally with the boss portion, the wall portion, and the drum portion.

3. The power transmission device according to claim 2, wherein
the drum portion and the second drum portion are extended in opposite directions to each other from substantially the same position in the radial direction in an outer periphery of the wall portion.

4. The power transmission device according to claim 3, wherein
the brake has a plurality of friction engagement plates that are fitted in splines formed in an inner peripheral surface of the drum portion, and
a lubricating oil supply path through which lubricating oil is supplied to the plurality of friction engagement plates is formed in the support member.

5. The power transmission device according to claim 4, wherein
the transmission case includes a case portion that accommodates at least the one rotary element,
the support member is fixed to the case portion such that the drum portion is fitted in the case portion,
the lubricating oil supply path includes an oil passage that is defined by a recess formed in at least one of an inner peripheral surface of the case portion and an outer peripheral surface of the drum portion, and a plurality of through holes that communicate with the oil passage and that extend in the radial direction, and
at least a part of the plurality of friction engagement plates is fitted in the drum portion so as to be located inside the recess.

6. The power transmission device according to claim 5, wherein
the brake includes a piston that together with the transmission case defines an engagement oil chamber and that presses the plurality of friction engagement plates according to an oil pressure supplied to the engagement oil chamber, and a plurality of return springs that bias the piston such that the piston is separated from the plurality of friction engagement plates, and
the plurality of return springs are disposed between a tip end of the drum portion and the piston.

7. The power transmission device according to claim 6, wherein
the brake is engaged when the transmission forms a starting speed.

8. The power transmission device according to claim 1, wherein
the brake has a plurality of friction engagement plates that are fitted in splines formed in an inner peripheral surface of the drum portion, and
a lubricating oil supply path through which lubricating oil is supplied to the plurality of friction engagement plates is formed in the support member.

9. The power transmission device according to claim 8, wherein
the transmission case includes a case portion that accommodates at least the one rotary element,
the support member is fixed to the case portion such that the drum portion is fitted in the case portion,
the lubricating oil supply path includes an oil passage that is defined by a recess formed in at least one of an inner peripheral surface of the case portion and an outer peripheral surface of the drum portion, and a plurality of through holes that communicate with the oil passage and that extend in the radial direction, and
at least a part of the plurality of friction engagement plates is fitted in the drum portion so as to be located inside the recess.

10. The power transmission device according to claim 9, wherein
the brake includes a piston that together with the transmission case defines an engagement oil chamber and that presses the plurality of friction engagement plates according to an oil pressure supplied to the engagement oil chamber, and a plurality of return springs that bias the piston such that the piston is separated from the plurality of friction engagement plates, and
the plurality of return springs are disposed between a tip end of the drum portion and the piston.

11. The power transmission device according to claim 8, wherein
the brake includes a piston that together with the transmission case defines an engagement oil chamber and that presses the plurality of friction engagement plates according to an oil pressure supplied to the engagement oil chamber, and a plurality of return springs that bias the piston such that the piston is separated from the plurality of friction engagement plates, and
the plurality of return springs are disposed between a tip end of the drum portion and the piston.

12. The power transmission device according to claim 1, wherein
the brake includes a piston that together with the transmission case defines an engagement oil chamber and that presses a plurality of friction engagement plates according to an oil pressure supplied to the engagement oil chamber, and a plurality of return springs that bias the piston such that the piston is separated from the plurality of friction engagement plates, and
the plurality of return springs are disposed between a tip end of the drum portion and the piston.

13. The power transmission device according to claim 1, wherein
the brake is engaged when the transmission forms a starting speed.

14. The power transmission device according to claim 2, wherein
the brake has a plurality of friction engagement plates that are fitted in splines formed in an inner peripheral surface of the drum portion, and
a lubricating oil supply path through which lubricating oil is supplied to the plurality of friction engagement plates is formed in the support member.

15. The power transmission device according to claim 14, wherein
the transmission case includes a case portion that accommodates at least the one rotary element,
the support member is fixed to the case portion such that the drum portion is fitted in the case portion,
the lubricating oil supply path includes an oil passage that is defined by a recess formed in at least one of an inner peripheral surface of the case portion and an outer peripheral surface of the drum portion, and a plurality of through holes that communicate with the oil passage and that extend in the radial direction, and
at least a part of the plurality of friction engagement plates is fitted in the drum portion so as to be located inside the recess.

16. The power transmission device according to claim 14, wherein
the brake includes a piston that together with the transmission case defines an engagement oil chamber and that presses the plurality of friction engagement plates according to an oil pressure supplied to the engagement oil chamber, and a plurality of return springs that bias the piston such that the piston is separated from the plurality of friction engagement plates, and
the plurality of return springs are disposed between a tip end of the drum portion and the piston.

17. The power transmission device according to claim 2, wherein
the brake includes a piston that together with the transmission case defines an engagement oil chamber and that presses a plurality of friction engagement plates according to an oil pressure supplied to the engagement oil chamber, and a plurality of return springs that bias the piston such that the piston is separated from the plurality of friction engagement plates, and
the plurality of return springs are disposed between a tip end of the drum portion and the piston.

18. The power transmission device according to claim 3, wherein
the brake includes a piston that together with the transmission case defines an engagement oil chamber and that presses a plurality of friction engagement plates according to an oil pressure supplied to the engagement oil chamber, and a plurality of return springs that bias the piston such that the piston is separated from the plurality of friction engagement plates, and
the plurality of return springs are disposed between a tip end of the drum portion and the piston.
